(19) United States
(12) Patent Application Publication
(10) Pub. No.: US 2026/0331383 A1
(43) Pub. Date: Oct. 22, 2026

(54) ELECTROLYTIC CAPACITOR AND MANUFACTURING METHOD

(71) Applicant: Nippon Chemi-Con Corporation, Tokyo (JP)

(72) Inventors: Hironori SUGIYAMA, Tokyo (JP); Yasuyoshi SHIRAISHI, Tokyo (JP); Shuichi ISHIMOTO, Tokyo (JP); Kenji TAMAMITSU, Tokyo (JP)

(21) Appl. No.: 19/101,215

(22) PCT Filed: Aug. 3, 2023
(86) PCT No.: PCT/JP2023/028472

§ 371 Date: Feb. 4, 2025

(30) Foreign Application Priority Data
Aug. 5, 2022 (JP) JP2022-125706

(51) Int. Cl. H01G 9/028; H01G 9/00; H01G 9/15

(52) U.S. Cl. CPC H01G 9/028; H01G 9/0032; H01G 9/0036; H01G 9/15

(57) ABSTRACT

The present disclosure provides an electrolytic capacitor using conductive polymers with better capacity, and a manufacturing method thereof. The electrolytic capacitor includes an electrolyte layer containing a conducive polymer and a plastic crystal. The manufacturing method of this electrolytic capacitor includes an electrolyte layer formation process of forming the electrolyte layer between a pair of electrodes. The electrolyte layer formation process includes a conductive polymer attachment process of attaching the conductive polymer on one or both of the pair of electrodes and a plastic crystal attachment process of attaching the plastic crystal on one or both of the pair of electrodes.

### FIELD OF INVENTION

The present disclosure relates to an electrolytic capacitor and a manufacturing method thereof.

### BACKGROUND

Electrolytic capacitors include valve action metal, such as tantalum or aluminum, as anode foil and cathode foil. A surface of the anode foil is enlarged by making the valve action metal into a sintered body or a shape such as etching foil, and the enlarged surface has a dielectric oxide film layer thereon. Electrolytic solution intervenes between the anode foil and the cathode foil. The electrolytic solution closely contacts the uneven surface of the anode foil and acts as a true cathode.

In recent years, a solid electrolytic capacitor using a solid electrolyte containing conductive polypyrrole, polyaniline, and polymers such as polythiophene has been employed. In particular, since the conductive polymer has high electrical conductivity, it contributes to the lower ESR of the electrolytic capacitor.

### PRIOR ART DOCUMENT

### Patent Document

Patent Document 1: WO2007/091656A

### SUMMARY OF INVENTION

### Problems to be Solved by Invention

Since the electrolytic solution contacts the dielectric oxide film layer of the anode foil closer than the solid electrolyte using conductive polymers, high capacity of the electrolytic capacitor can be achieved more easily. Therefore, the electrolytic capacitor using conductive polymers also requires excellent ESR and excellent capacitance.

The present disclosure has been proposed to address the above problems, and an objective is to provide an electrolytic capacitor using conductive polymers with better capacity, and a manufacturing method thereof.

### Means to Solve the Problem

To address the above problem, an electrolytic capacitor of the present embodiment includes an electrolyte layer containing a conductive polymer and a plastic crystal. The electrolytic capacitor may include an anode body and a cathode body.

The conductive polymer may include poly(3,4-ethylenedioxythiophene) and polystyrene sulfonic acid.

The plastic crystal may further include a combination of a cation and an anion that is different from a cation component and an anion component of the plastic crystal.

When an amount of the conductive polymer is one, an amount of the plastic crystal may be two to twelve times the amount of the conductive polymer by weight.

Furthermore, to address the above problems, a manufacturing method of the electrolytic capacitor of the present embodiment includes an electrolyte layer formation process of forming an electrolyte layer between a pair of electrodes, and the electrolyte layer formation process includes a conductive polymer attachment process of attaching a conductive polymer on one or both of the pair of electrodes and a plastic crystal attachment process of attaching a plastic crystal on one or both of the pair of electrodes.

The conductive polymer attachment process may include an impregnation process of impregnating liquid containing the conductive polymer between the pair of electrodes.

In the plastic crystal attachment process, the plastic crystal including a combination of a cation and an anion that is different from a cation component and anion component of the plastic crystal may be attached.

In the plastic crystal attachment process, when an amount of the conductive polymer is one, an amount of the plastic crystal may be two to twelve times the amount of the conductive polymer by weight.

### Effect of Invention

According to the present disclosure, the electrolytic capacitor has excellent capacity compared with the electrolytic capacitor using conductive polymers.

### EMBODIMENTS

Hereinafter, embodiments of the present disclosure will be described. Note that the present disclosure is not limited to the following embodiments.

### (Overall Configuration)

An electrolytic capacitor is a passive element that gains capacitance by dielectric polarization of dielectric oxide film and stores and discharges electric charge. Furthermore, the electrolytic capacitor includes a pair of electrodes and an electrolyte layer sandwiched between the electrodes. One of the electrodes is an anode body and dielectric oxide film is formed on a surface thereof. The other of the electrodes is a cathode body. The electrolyte layer contains a conductive polymer and a plastic crystal.

The conductive polymer is a self-doped conjugated polymer doped by dopant molecules in molecules or a conjugated polymer doped by external dopant molecules. The conjugated polymer is obtained by chemical oxidative polymerization or electrolytic oxidative polymerization of monomers with a n-conjugated double bond or derivatives thereof. The dopant or the external dopant molecule is an acceptor that easily accepts electrons in the conjugated polymer or a donor that easily donates electrons to the conjugated polymer, so that the conductive polymer exhibits high conductivity.

The plastic crystal is also referred to as a plastic crystal and has ordered orientation and disordered orientation. That is, the plastic crystal has a three-dimensional crystal lattice in which anions and cations are regularly arranged, while the anions and the cations have rotational irregularity.

The electrolyte layer containing the conductive polymer and the plastic crystal intervenes between the anode body and the cathode body. In other words, the anode body and the cathode body are arranged to face each other via the electrolyte layer. The electrolyte layer is arranged to adhere to the dielectric oxide film of the anode body and be linked between the dielectric oxide film and the cathode body, creating a conductive path and acting as a true cathode.

The anode body and the cathode body are arranged in a laminated-type in which they are laminated alternately via the electrolyte layer, or arranged in a wound-type in which they are laminated alternately via the electrolyte layer and are wound. In the laminated-type, other than a planar-type in which an exterior is omitted, for example, a capacitor element is sealed by covering the capacitor element by laminate film or by molding, dip coating, or printing resin such as heat-resistant resin and insulation resin.

Otherwise, the anode body and the cathode body are arranged in a wound-type in which they are laminated alternately and wound via the electrolyte layer. For example, in the wound-type, the capacitor element is inserted in an outer casing with a bottom, and an opened end of the outer casing is sealed by a crimping process using a sealing body. For example, the sealing body is formed of rubber or formed of a laminate of rubber and a hard substrate. The rubber may be ethylene propylene rubber or butyl rubber, etc.

Note that a separator is provided the anode body and the cathode body, which separates the anode body and the cathode body and holds the electrolyte layer between the anode body and the cathode body, to prevent short-circuit between the anode body and the cathode body. If the electrolyte layer can keep its shape on its own and can separate the anode body and the cathode body, the separator can be omitted from the electrolytic capacitor.

### (Anode Body)

In such electrolytic capacitors, the anode body is a foil body formed of valve action metal. In the wound-type electrolytic capacitor, the anode body is a long strip of elongated valve action metal, and in the laminated-type electrolytic capacitor, the anode body is a sintered body formed by molding and sintering a flat plate or powder into a planar shape. The valve action metal is aluminum, tantalum, niobium, niobium oxide, titanium, hafnium, zirconium, zinc, tungsten, bismuth, and antimony, etc. The purity of the anode body is desirably 99.9% or more, and impurities such as silicon, iron, copper, magnesium, and zinc may be included.

An enlarged surface layer is formed on one or both surfaces of the anode body. The enlarged surface layer is an etched layer in which etching is performed on foil, a sintered layer in which powder of valve action metal is sintered, or a vapor-deposited layer in which particles of valve action metal are vapor-deposited in foil. That is, the enlarged surface layer has a porous structure and is formed by tunnel-shaped pits, spongy pits, or air gaps between dense powder bodies or particles.

The tunnel-shaped etching pits are holes dug in the thickness direction of the foil. Typically, the tunnel etching pits are formed by applying DC current on the anode body in aqueous acidic solution in which halogen ions are present, such as hydrochloric acid. Furthermore, the tunnel etching pits are enlarged by applying DC current on the anode body in aqueous acidic solution such as nitric acid. The spongy pits make the enlarged surface layer a spongy layer with a series of fine spatial air gaps. The spongy etching pits are formed by applying AC current on the anode body in aqueous acidic solution in which halogen ions are present, such as hydrochloric acid.

The sintered layer is formed by obtaining powder of valve action metal same as or different from that of the foil body using grinding, atomizing, melt-spinning, rotating disk, rotating electrode, or other method, making a paste from the powder using a binder or a solvent, applying the paste on the foil body, drying the foil body, and heating and sintering the foil body in vacuum or in reduction atmosphere. The atomizing may be either of water atomizing, gas atomizing, or water-gas atomizing. For example, the sintered layer is produced by resistance heating vapor-deposition or electron beam heating vapor-deposition. The sintered layer is formed by heating and evaporating valve action metal same as or different from that of the foil body using resistive heat and electron beam energy, and depositing vapor of the particles of the valve action metal on the surface of the foil body.

The dielectric oxide film is formed on one or both surfaces of the anode body on which the enlarged surface layer is formed. Typically, the dielectric oxide film is oxide film formed on the surface layer of the anode foil, and when the anode body is made of aluminum, the dielectric oxide film is an aluminum oxide layer obtained by oxidizing the surface layer of the enlarged surface layer. In the chemical conversion treatment to form the dielectric oxide film, voltage is applied in the anode body in chemical conversion solution to achieve the desired withstand voltage. The chemical conversion solution is solution without halogen ions, and for example is phosphoric acid-based chemical conversion solution such as ammonium dihydrogenphosphate, boric acid-based chemical conversion solution such as ammonium borate, and adipic acid-based chemical conversion solution such as ammonium adipate, etc.

An anode lead wire is connected to the anode body and is drawn out of the capacitor element. The capacitor element is an assembly of the anode body, the cathode body, the electrolyte layer, and the separator. The anode lead wire is connected by stitching, cold-welding, ultrasonic welding, and laser welding, etc.

### (Cathode Body)

When the electrolytic capacitor is the wound-type, it is preferable that the cathode body is a elongated foil body formed of valve action metal. The purity of the cathode body is preferably 99% or more. The enlarged surface layer is formed on the cathode body, like the anode body. The cathode body may be a plane foil without the enlarged surface layer. The cathode body may have natural oxide film, or thin oxide film (about 1 to 10 V) formed by the chemical conversion treatment. The natural oxide film is formed when oxygen in the air reacts with the cathode body. In addition, a layer consisting of metal nitrides, metal carbides, or metal carbonitrides may be formed in the cathode body by vapor-deposition, or a layer containing carbon may be formed on the surface of the cathode body.

Otherwise, when the electrolytic capacitor is the laminate-type, it is preferable that the cathode body is a laminate of a metal layer and a carbon layer. The carbon layer of the cathode body is arranged toward the anode body. The carbon layer is formed by applying paste of carbon on the electrolyte layer that has been formed on the anode body, and heating and curing the paste. The metal layer may be a silver layer, and is formed by applying paste of the metal on the carbon layer and heating and curing the paste.

A cathode lead wire is connected to the cathode body and is drawn out of the capacitor element. The cathode lead wire is connected by stitching, cold-welding, ultrasonic welding, and laser welding, etc.

### (Electrolyte Layer)

### (Conductive Polymer)

Known polymers may be used for the conjugated polymer without limitation. For example, the conjugated polymer may be polypyrrole, polythiophene, polyfuran, polyaniline, polyacetylene, polyphenylene, polyphenylenevinylene, polyacene, and polythiophenevinylene, etc. These conjugated polymers may be used in single or in combination of two or more, and may further be a copolymer of two or more types of monomers.

Among the above-described conjugated polymers, conjugated polymers formed by polymerizing thiophene or derivatives thereof are preferable, and conjugated polymers in which 3,4-ethylenedioxythiophene (that is, 2,3-dihydrothieno[3,4-b][1,4]dioxin), 3-alkylthiophene, 3-alkoxythiophene, 3-alkyl-4-alkoxythiophene, 3,4-alkylthiophene, 3,4-alkoxythiophene, or derivatives thereof are polymerized are preferable. The thiophene derivatives may preferably be compounds selected from thiophene with substituents at 3-position and 4-position, and the 3-position and 4-position substituents of the thiophene ring may form a ring together with the 3-position and 4-position carbon. It is preferable that the carbon number of an alkyl group and an alkoxy group is 1 to 16.

In particular, polymer a of 3,4-ethylenedioxythiophene which is called EDOT, that is, poly(3,4-ethylenedioxythiophene) which is called PEDOT is particularly preferable. Furthermore, substituents may be added to 3,4-ethylenedioxythiophene. For example, alkylated ethylenedioxythiophene to which an alkyl group with carbon number of 1 to 5 is added as a substituent may be used. For example, alkylated ethylenedioxythiophene may be methylated ethylenedioxythiophene (that is, 2-methyl-2,3-dihydro-thieno[3,4-b][1,4]dioxin), ethylated ethylenedioxythiophene (that is, 2-ethyl-2,3-dihydro-thieno[3,4-b][1,4]dioxin), butylated ethylenedioxythiophene (that is, 2-butyl-2,3-dihydro-thieno[3,4-b][1,4]dioxin), and 2-alkyl-3,4-ethylenedioxythiophene may be used.

As a dopant, known dopants may be used without limitation. The dopant may be used in single or in combination of two or more. Furthermore, the dopant may also be polymers or monomers. For example, the dopant may be inorganic acid such as polyanions, boric acid, nitric acid, and phosphoric acid, and organic acid such as acetic acid, oxalic acid, citric acid, tartaric acid, squaric acid, logisonic acid, croconic acid, salicylic acid, p-toluenesulfonic acid, 1,2-dihydroxy-3,5-benzenedisulfonic acid, methanesulfonic acid, trifluoromethanesulfonic acid, borodisalicylic acid, bisoxalate borate acid, sulfonylimide acid, dodecylbenzenesulfonic acid, propylnaphthalenesulfonic acid, and butylnaphthalenesulfonic acid.

For example, the polyanion may be polymers consisting of only component units with anion groups or polymers consisting of component units with anion groups and component units without anion groups, and may be substituted or unsubstituted polyalkylene, substituted or unsubstituted polyalkenylene, substituted or unsubstituted polyimide, substituted or unsubstituted polyamide, and substituted or unsubstituted polyester. In particular, the polyanion may be polyvinyl sulfonic acid, polystyrene sulfonic acid, polyaryl sulfonic acid, polyacrylic sulfonic acid, polymethacrylic sulfonic acid, poly(2-acrylamide-2-methylpropane sulfonic acid), polyisoprene sulfonic acid, polyacrylic acid, polymethacrylic acid, and polymaleic acid, etc.

The conductive polymer is produced by chemical oxidative polymerization or electrolytic oxidative polymerization. In the chemical oxidative polymerization, solution containing monomers that are monomer units of the conductive polymer and an oxidizing agent are mixed and polymerized. The oxidizing agent may be any known compounds that release dopants, may be trivalent iron salt such as iron (III) p-toluene sulfonate, iron (III) naphthalene sulfonate, and iron (III) anthraquinone sulfonate, or peroxodisulfate salt such as peroxiodisulfuric acid, ammonium peroxodisulfate, and sodium peroxodisulfate, and may be used in single or in combination of two or more. Although there is no strict limitation for the polymerization temperature, the temperature is generally in the range of 10 to 200° C. The polymerization time is generally in the range of 10 minutes to 30 hours.

In the electrolytic oxidative polymerization, monomers that are monomer units of the conductive polymer and a support electrolyte are mixed and polymerized by the constant potential method, the constant current method, or the potential sweep method. The support electrolyte contains at least one type of compound selected from a group consisting of borodisalicylic acid and borodisalicylic acid salt. The salt may be alkali metal salt such as lithium salt, sodium salt, and potassium salt, ammonium salt, alkyl ammonium salt such as ethyl ammonium salt and butyl ammonium salt, dialkyl ammonium salt such as diethyl ammonium salt and dibutyl ammonium salt, trialkyl ammonium salt such as triethyl ammonium salt and tributyl ammonium salt, and tetraalkyl ammonium salt such as tetraethyl ammonium salt and tetrabutyl ammonium salt.

In the constant potential method, potential of 1.0 to 1.5 V is suitable for a reference electrode, in the constant current method, current of 1 to 10000 μA/cm² is suitable, and in the potential sweep method, it is suitable to sweep the range of 0 to 1.5 V for a reference electrode at a rate of 5 to 200 mV/second. Although there is no strict limitation for the polymerization temperature, the temperature is generally in the range of 10 to 60° C. The polymerization time is generally in the range of 10 minutes to 30 hours.

In the chemical oxidative polymerization or electrolytic oxidative polymerization, the solvent to add the monomer, the oxidizing agent or the support electrolyte is not particularly limited if the solvent can dissolve the desired amount of the monomers and the support electrolyte and does not affect the electrolytic oxidative polymerization. For example, the solvent may be water, methanol, ethanol, isopropanol, butanol, ethylene glycol, acetonitrile, butyronitrile, acetone, methylethylketone, tetrahydrofuran, 1,4-dioxan, Y-butyrolactone, methyl acetate, ethyl acetate, methyl benzoate, ethyl benzoate, ethylene carbonate, propylene carbonate, nitromethane, nitrobenzene, sulfolane, and dimethyl sulfolane. These solvents may be used in single or in combination of two or more.

The conductive polymer is formed in the electrolytic capacitor by immersing an attaching target to attach the conductive polymer in the solution of the monomers that are the monomer units of the conductive polymer and the oxidizing agent or the support electrolyte for polymerization reaction. The attaching target at least includes the anode body. The attaching target of the conductive polymer may also include one or both of the cathode body and the separator, in addition to the anode body. Furthermore, the attaching target may be the capacitor element that is the assembly of the anode body, the cathode body, and the separator, and may be immersed in the solution of the monomers that are the monomer units of the conductive polymer and the oxidizing agent or the support electrolyte for polymerization reaction.

Furthermore, the conductive polymer may be formed in the electrolytic capacitor by using an impregnation method in which the attaching target is impregnated with conductive polymer solution in which particles or powder of the conductive polymer is dispersed or dissolved. The conductive polymer solution is prepared by purifying the solution after the chemical oxidative polymerization or electrolytic oxidative polymerization using ultrafiltration, cation exchange, and anion exchange, removing residual monomers and impurities, and dispersing the solution.

The solvent of the conductive polymer solution be any solvent if the conductive polymer disperses or dissolves thereto, and water, or the mixture of water and organic solvents is preferable. The organic solvent of the conductive polymer dispersion may be polar solvents, alcohol, esters, hydrocarbon, carbonate compounds, ether compounds, linear ether, heterocyclic compounds, and nitrile compounds, etc.

The polar may be N-methyl-2-solvent pyrrolidone, N, N-dimethylformamide, N, N-dimethylacetamide, and dimethylsulfoxide. The alcohol may be methanol, ethanol, propanol, and butanol, etc. The ester may be ethyl acetate, propyl acetate, and butyl acetate, etc. The hydrocarbon may be hexane, heptane, benzene, toluene, and xylene, etc. The carbonate compound may be ethylene carbonate and propylene carbonate, etc. The ether compound may be dioxane, diethyl ether, etc. The linear ether may be ethylene glycol alkyl ether, propylene glycol alkyl ether, polyethylene glycol dialkyl ether, and polypropylene glycol alkyl ether, etc. The heterocyclic compound may be 3-methyl-2-oxazolidinone, etc. The nitrile compound may be acetonitrile, glutaronitrile, methoxyacetonitrile, propionitrile, and benzonitrile, etc.

The pH of the conductive polymer solution is adjusted, and polyhydric alcohol and various additives may be added as necessary. For example, a pH adjuster may be ammonia water. The polyhydric alcohol may be sorbitol, ethylene glycol, diethylene glycol, triethylene glycol, polyoxyethylene glycol, glycerin, polyoxyethylene glycerin, xylitol, erythritol, mannitol, dipentaerythritol, pentaerythritol, or combination of two or more. Since the boiling point of the polyhydric alcohol is high, the polyhydric alcohol remains in the solid electrolyte layer even after the attaching target is impregnated with the conductive polymer solution and is dried, so that ESR reduction and withstand voltage improvement the of electrolytic capacitor are achieved. For example, the additive may be organic binders, surfactant, dispersant, defoamer, coupling agent, antioxidant, and UV absorber, etc.

After the conductive polymer solution is impregnated to the attaching target, the solvent is removed by drying process. For example, the temperature environment in the drying process is 40 to 200° C., and the drying time is 3 to 180 minutes. The drying process may be repeated for multiple times. The drying process may be performed under the depressurized environment, for example, under the pressure of 5 to 100 kPa. The drying process may be divided into pre-drying and main-drying. The conductive polymer solution may be applied by droplet or by spraying other than the immersion.

### (Plastic Crystal)

The type of the anion component and the cation component forming the plastic crystal is not particularly limited if they are in the solid state rather than ionic liquid within the objective temperature range in which the electrolytic capacitor is used.

The anion component forming the plastic crystal may be various amide anions, tris(trifluoromethanesulfonyl)methanide anions, various phosphate anions, various borate anions, various sulfonic anions, tetrafluoroaluminate anions, mandelate anions, and benzoate anions.

In various amide anions, two hydrogen atoms of NH₂ anion is substituted with a perfluoroalkylsulfonyl group, a fluorosulfonyl group, or both. For example, various amide anions include anions with linear chain, and various bis(perfluoroalkylsulfonyl)amide anions expressed by the following chemical formula (1), a bis(fluorosulfonyl)amide anion, and various N-(fluorosulfonyl)-N-(perfluoroalkylsulfonyl)amide anions.

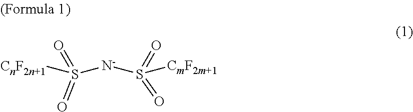

In the chemical formula (1), n and m are an integer of 0 or more, and the carbon number is arbitrary.

In the chemical formula (1), when n and m are equal to or more than 1, it is a bis(perfluoroalkylsulfonyl)amide anion. In detail, a bis(perfluoroalkylsulfonyl)amide anion may be a bis(trifluoromethanesulfonyl)amide anion (TFSA anion) expressed by the below chemical formula (2) and a bis(pentafluoroethylsulfonyl)amide anion (BETA anion) expressed by the below chemical formula (3).

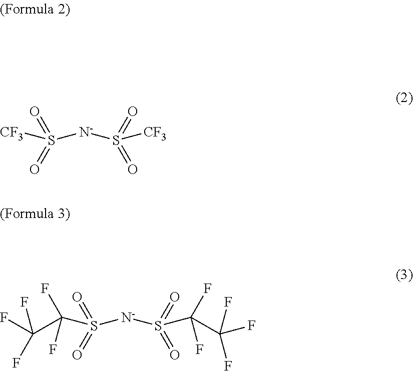 [SMILES: O=S(=O)([N-]S(=O)(=O)C(F)(F)F)C(F)(F)F ; O=S(=O)([N-]S(=O)(=O)C(F)(F)C(F)(F)F)C(F)(F)C(F)(F)F]

Furthermore, a bis(perfluoroalkylsulfonyl)amide anion may be a (pentafluoroethylsulfonyl)trifluoromethanesulfonylamide anion expressed by the below chemical formula (4), where n is 1 and m is 2 in the chemical formula (1).

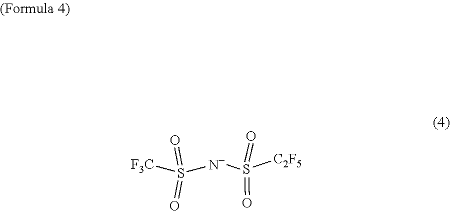

In the chemical formula (1), when a group with 0 carbon is a fluorosulfonyl group, and when n and m are 0, it is a bis(fluorosulfonyl)amide anion (FSA anion) expressed by the below chemical formula (5).

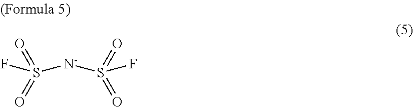

In the chemical formula (1), when n is 0 and m is equal to or more than 1, it is a N-(fluorosulfonyl)-N-(perfluoroalkylsulfonyl)amide anion expressed by the below chemical formula (6). In detail, a N-(fluorosulfonyl)-N-(perfluoroalkylsulfonyl)amide anion may be a N-(fluorosulfonyl)-N-(trifluoromethanesulfonyl)amide anion expressed by the below chemical formula (7) where m is 1, and a N-(fluorosulfonyl)-N-(pentafluoroethylsulfonyl)amide anion expressed by the below chemical formula (8) where m is 2.

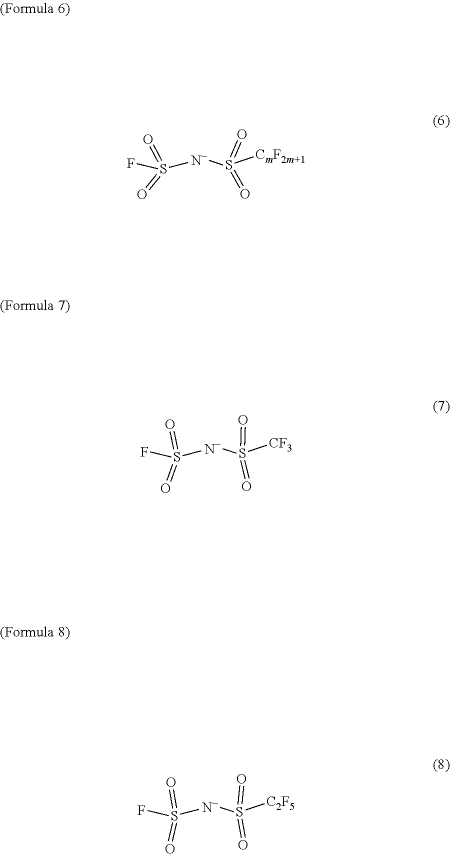

Furthermore, various amide anions include a (perfluoroalkylsulfonyl)fluoroacetamide anion expressed by the below chemical formula (9), where two hydrogen atoms of NH₂ anion is substituted with a perfluoroalkylsulfonyl group and a fluoroacetyl group.

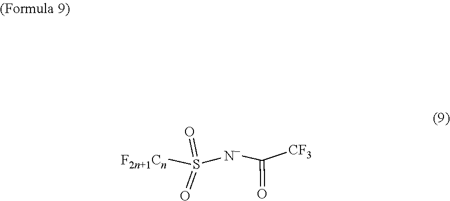

In the chemical formula (9), n is an integer of 0 or more, and carbon number is arbitrary.

Furthermore, various amide anions include anions with heterocyclic rings of 5-membered ring and 6-membered ring, and include a N, N-hexafluoro-1,3-disulfonylamide anion (CFSA anion) expressed by the below chemical formula (10) and a N, N-pentafluoro-1,3-disulfonylamide anion expressed by the below chemical formula (11).

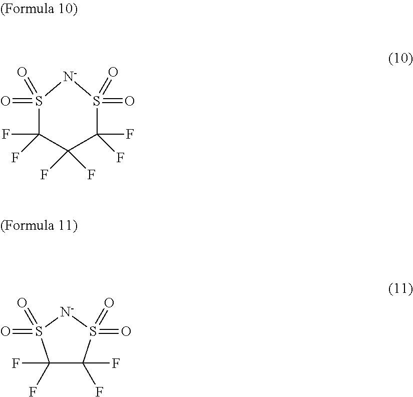 [SMILES: O=S1(=O)[N-]S(=O)(=O)C(F)(F)C(F)(F)C1(F)F ; O=S1(=O)[N-]S(=O)(=O)C(F)(F)C1(F)F]

A tris(trifluoromethanesulfonyl)methanide anion (TFSM anion) is expressed by the below chemical formula (12).

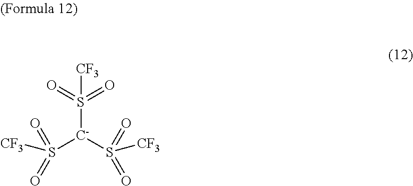 [SMILES: O=S(=O)([C-](S(=O)(=O)C(F)(F)F)S(=O)(=O)C(F)(F)F)C(F)(F)F]

Various phosphate anions are a hexafluorophosphate anion (PF₆ anion) expressed by the below chemical formula (13), or various perfluoroalkylphosphate anions expressed by the below chemical formula (14) where some fluorine atoms of PF₆ are substituted with a fluoroalkyl group.

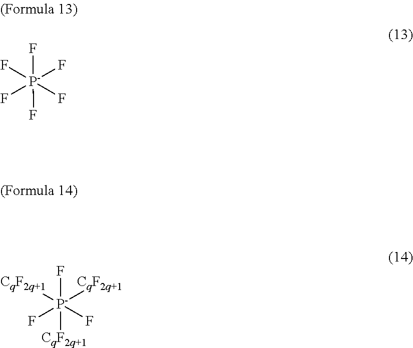

In the chemical formula (14), q is an integer of 1 or more, and carbon number is arbitrary.

In detail, it may be a tris(pentafluoroethyl)trifluorophosphate anion (FAP anion) expressed by the below chemical formula (15).

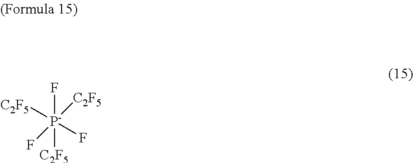

Various borate anions are a tetrafluoroborate anion (BF₄ anion) expressed by the below chemical formula (16) and various perfluoroalkylborate anions expressed by the below chemical formula (17) where some fluorine atoms of BF₄ are substituted with a fluoroalkyl group. In detail, for example, various perfluoroalkylborate anions may be a mono(fluoroalkyl)trifluoroborate anion and a bis(fluoroalkyl)fluoroborate anion.

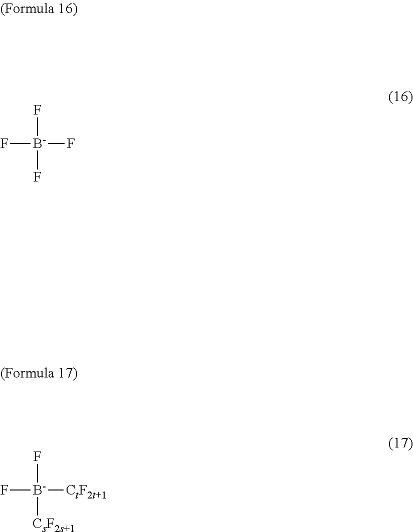

In the formula, s is an integer of 0 or more, t is an integer of 1 or more, and carbon number is arbitrary.

Furthermore, various borate anions may be a borate anion expressed by the below chemical formula (18).

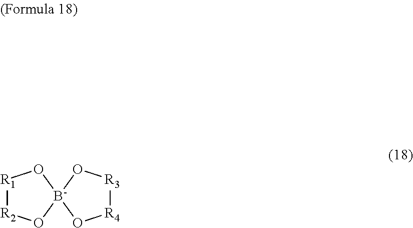

In the formula, R1 and R2 are each independently a ketone group or a benzyl group with one hydrogen atom at the benzyl position removed, or R1 and R2 are carbon atoms in a common aromatic 6-membered ring. In the formula, R3 and R4 are each independently a ketone group or a benzyl group with one hydrogen atom at the benzyl position removed, or R3 and R4 are carbon atoms in a common aromatic 6-membered ring.

In the chemical formula (18), when all R1, R2, R3, and R4 are ketone groups, it is a bis(oxalate)borate anion (BoB) anion expressed by the below chemical formula (18A).

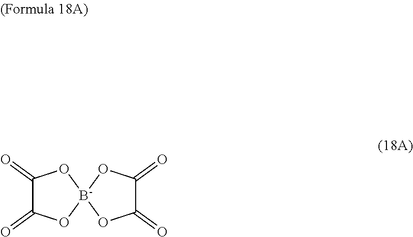 [SMILES: O=C1O[B-]2(OC1=O)OC(=O)C(=O)O2]

Furthermore, in the chemical formula (18), when R1 and R2 are carbon atoms in a common aromatic 6-membered ring and R3 and R4 are carbon atoms in a common aromatic 6-membered ring, it is a bis(pyrocatecholato)borate anion expressed by the below chemical formula (18B).

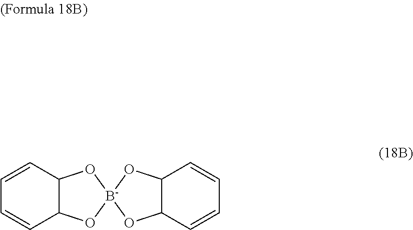 [SMILES: C1=CC2O[B-]3(OC2C=C1)OC1C=CC=CC1O3]

In the chemical formula (18), when R1 and R4 are benzyl groups with one hydrogen atom at the benzyl position removed, and R2 and R3 are ketone groups, it is a bis(mandelate)borate anion expressed by the below chemical formula (18C).

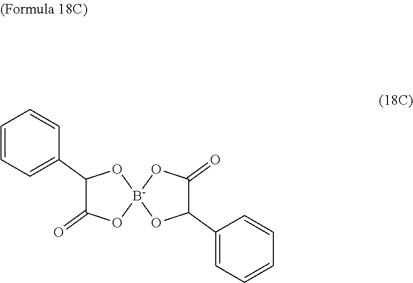 [SMILES: O=C1O[B-]2(OC(=O)C(c3ccccc3)O2)OC1c1ccccc1]

Furthermore, various borate anions may be a borate anion expressed by the below chemical formula (19).

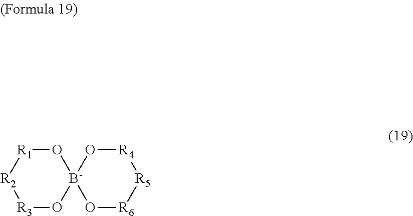

In the formula, R1 to R6 are each independently a ketone group or a methylene group. Otherwise, in the formula, either of R1 or R3 is a ketone group or a methylene group, and other combination of R1 and R2 or R2 and R3 is a carbon atom of a common aromatic 6-membered ring. Then, in the formula, either of R4 or R6 is a ketone group or a methylene group, and other combination of R4 and R5 or R5 and R6 is a carbon atom of a common aromatic 6-membered ring. The aromatic 6-membered ring may have one or four methyl groups, and is a part of a polycyclic aromatic ring with two or more aromatic rings, such as a naphthalene ring.

In the chemical formula (19), when R1 and R6 are ketone groups, R2 and R3 are carbon atoms in a common aromatic 6-membered ring, and R4 and R5 are carbon atoms in a common aromatic 6-membered ring, it is a bis(salicylato)borate anion (BScB anion) expressed by the below chemical formula (19A).

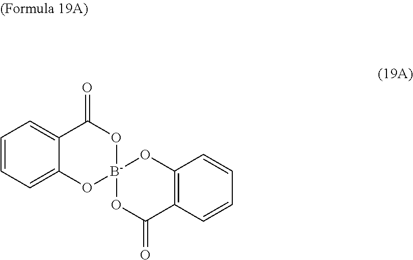 [SMILES: O=C1O[B-]2(OC(=O)c3ccccc3O2)Oc2ccccc21]

In the chemical formula (19), when R1 and R6 are ketone groups, R2 and R3 are carbon atoms in a common aromatic 6-membered ring, R4 and R5 are carbon atoms in a common aromatic 6-membered ring, and both aromatic 6-membered ring each has four methyl groups, it is a bis(tetramethylsalicylato)borate anion expressed by the below chemical formula (19B).

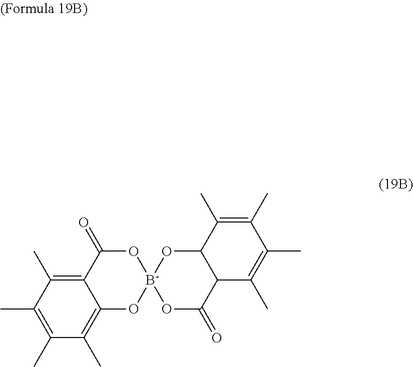

In the chemical formula (19), when R1 and R6 are ketone groups, R2 and R3 are carbon atoms in a common aromatic 6-membered ring, R4 and R5 are carbon atoms in a common aromatic 6-membered ring, and both aromatic 6-membered ring each has one methyl group, it is a bis(methylsalicylato)borate anion (BmScB anion) expressed by the below chemical formula (19C).

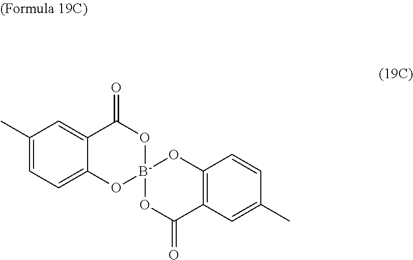

In the chemical formula 19, when R1 and R6 are ketone groups, R2 and R3 are carbon atoms in a common naphthalene ring, and R4 and R5 are carbon atoms in a common naphthalene ring, it is a bis(1-hydroxy-2-naphtholato)borate anion expressed by the below chemical formula (20A), a bis(2-hydroxy-1-naphtholato)borate anion (BhNB anion) expressed by the below chemical formula (20B), and a bis(3-hydroxy-2-naphtholato)borate anion expressed by the below chemical formula (20C).

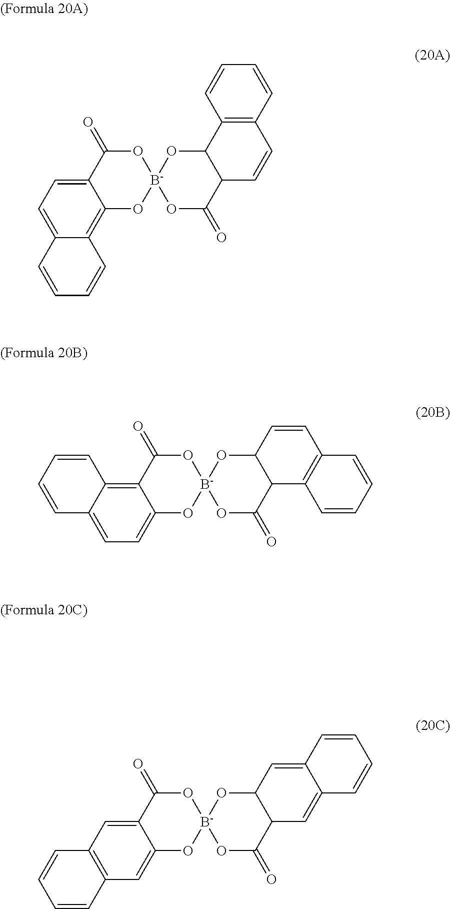 [SMILES: O=C1O[B-]2(OC(=O)C3C=Cc4ccccc4C3O2)Oc2c1ccc1ccccc21 ; O=C1O[B-]2(OC(=O)C3c4ccccc4C=CC3O2)Oc2ccc3ccccc3c21 ; O=C1O[B-]2(OC(=O)C3C=c4ccccc4=CC3O2)Oc2cc3ccccc3cc21]

Various sulfonic anions may be an alkylsulfonic anion expressed by the below chemical formula (21) and various perfluoroalkylsulfonic anions expressed by the below chemical formula (22).

(Formula 21)

CₓH₂ₓ₊₁SO₃⁻ (21)

In the chemical formula (21), x is an integer of 1 to 4.

(Formula 22)

C_{y}F_{2y+1}SO₃⁻ (22)

In the chemical formula (22), y is an integer of 1 to 4.

In detail, various perfluoroalkylsulfonic acid anions may be a trifluoromethanesulfonic acid anion where y is 1 in the formula (22), a pentafluoroethylsulfonic acid anion where y is 2 in the formula (22), heptafluoropropanesulfonic acid anions where y is 3 in the formula (22), and a nonafluorobutanesulfonic acid anion where y is 4 in the formula (22).

A tetrafluoroaluminate anion is expressed by the below chemical formula (23).

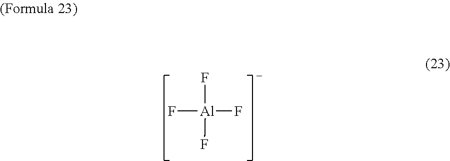

A mandelate anion is expressed by the below chemical formula (24).

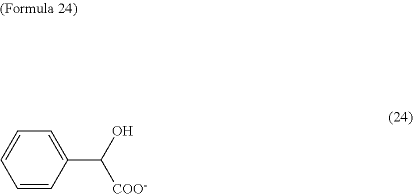

A benzoate anion is expressed by the below chemical formula (25).

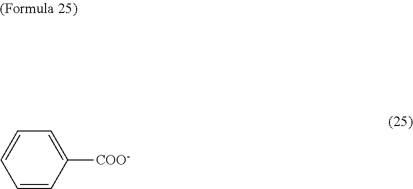

A cation component forming the plastic crystal may be various quaternary ammonium cations, various pyrrolidinium cations, various piperidinium cations, various imidazolium cations, and various phosphonium cations.

The quaternary ammonium cation may be a tetraalkylammonium cation expressed the below chemical formula (26) substituted with linear alkyl groups of any carbon number.

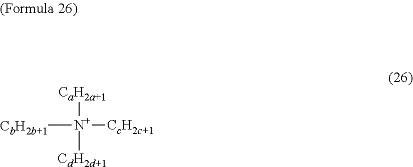

In formula, a, b, c, and d are an integer 1 or more, and carbon number is arbitrary.

In the above chemical formula (26), when a, b, c, and d are 2, it is a tetraethylammonium cation (TEA cation) expressed by the below chemical formula (27).

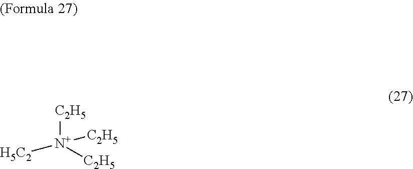

In the above chemical formula (26), when a, b, and c are 2 and d is 1, it is a triethylmethylammonium cation (TEMA cation) expressed by the below chemical formula (28).

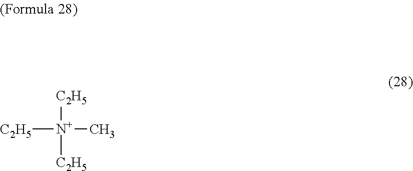

Furthermore, the quaternary ammonium cation may be a pyrrolidinium cation expressed by the below chemical formula (29) which is a 5-membered ring to which a methyl group, an ethyl group, or an isopropyl group is connected.

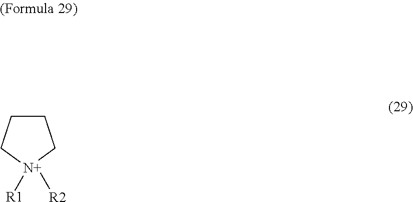

In the formula, R1 and R2 are methyl groups, ethyl groups, or isopropyl groups.

For example, a detail example of 5-membered pyrrolidinium cation generalized by the above chemical formula (29) may be a N-ethyl-N-methylpyrrolidinium cation (P12 cation) expressed by the below chemical formula (30), a N-isopropyl-N-methylpyrrolidinium cation (P13iso cation) expressed by the below chemical formula (31), and a N, N-diethylpyrrolidinium cation (P22 cation) expressed by the below chemical formula (32).

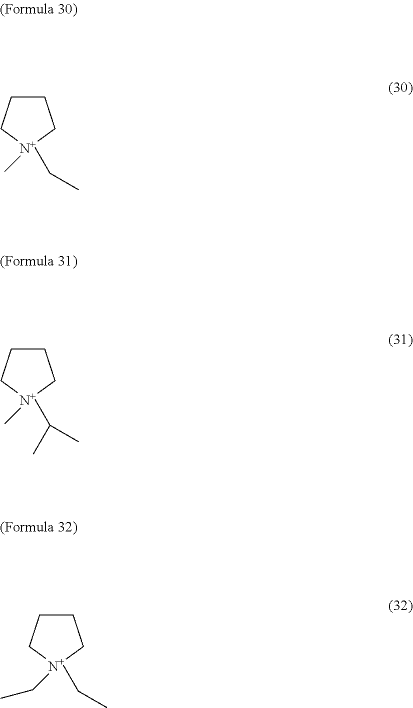

Furthermore, the quaternary ammonium cation may be a spiro pyrrolidinium cation (SBP cation) expressed by the below chemical formula (33).

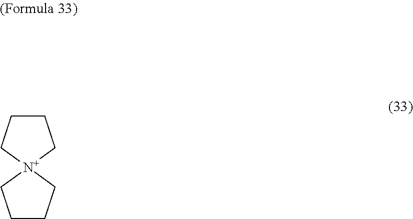

Various piperidinium cations may be a piperidinium cation expressed by the below chemical formula (34) which is a 6-membered ring to which a methyl group, an ethyl group, or an isopropyl group is connected.

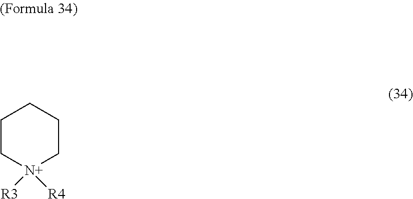

In the formula, R3 and R4 are methyl groups, ethyl groups, or isopropyl groups.

For example, a detailed example of 6-membered piperidinium cation generalized by the above chemical formula (34) may be a 1-ethyl-1-methylpiperidinium cation expressed by the below chemical formula (35), where R3 is a methyl group and R4 is an ethyl group.

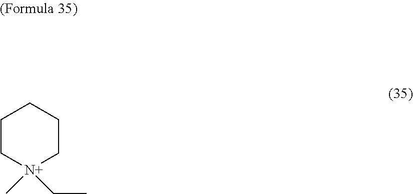

Various imidazolium cations are a 1,3-dialkylimidazolium or 1,2,3-trialkylimidazolium cation expressed by the below chemical formula (36).

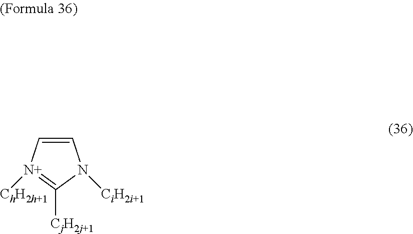

In the formula, h and i are an integer of 1 to 3, and j is 0 or 1.

In the chemical formula (36), when j is 0 and h and i are 1, it is a 1,3-dimethylimidazolium cation (DMI cation) expressed by the below chemical formula (37). The 2-position of this DMI cation may be substituted with a methyl group.

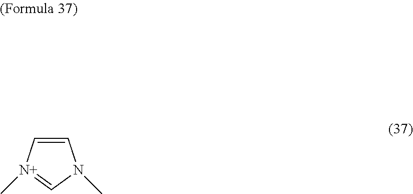

In the chemical formula (36), when j is 0, h is 1, and i is 2, it is a 1-ethyl-3-methylimidazolium cation (EMI cation) expressed by the below chemical formula (38). The 2-position of this EMI cation may be substituted with a methyl group.

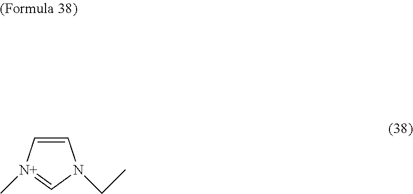

In the chemical formula (36), when j is 0, h is 1, and i is 3, it is a 1-methyl-3-propylimidazolium cation (MPI cation) expressed by the below chemical formula (39). The 2-position of this MPI cation may be substituted with a methyl group.

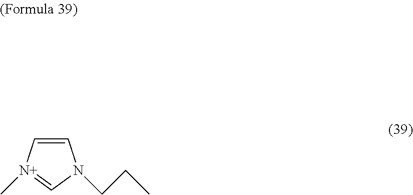

Various phosphonium cations may be a tetraalkylphosphonium cation expressed by the below chemical formula (40) substituted with linear alkyl groups of any carbon number. For example, tetraalkylphosphonium cation may be a tetraethylphosphonium cation (TEP cation).

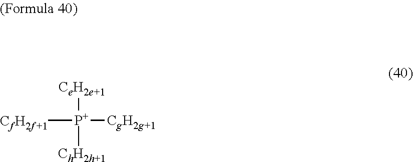

In the formula, e, f, g, and h are an integer of 1 or more, and carbon number is arbitrary.

Two or more types of the plastic crystals may be contained in the electrolyte layer. When mixing and using two or more types of the anion components that can form the plastic crystal in the electrolyte layer, the ion conductivity of the electrolyte layer is improved more than when single anion component is used. Furthermore, when mixing and using two or more types of the cation components that can form the plastic crystal in the electrolyte layer, the ion conductivity of the electrolyte layer is improved more than when single cation component is used.

When two or more types of the plastic crystals are contained, the plastic crystal of same anions may be contained in the electrolyte layer, the plastic crystal of same cations may be contained in the electrolyte layer, and the plastic crystal of different anion components and cation components may be contained. The formulation ratio of the different plastic crystals in the electrolyte layer may be equimolar amount or different amount.

Furthermore, the plastic crystal may include a combination of a cation and an anion that are different from the cation component and the anion component of the plastic crystal. The cations and anions included in the plastic crystal should be ion-dissociated in the temperature range in which the electrolytic capacitor operates. For example, such cations and anions may be included in the plastic crystal as ionic liquid. The ionic liquid is salt present in a liquid state in the temperature range including room temperature and is liquid only formed of ions.

The cation included in the plastic crystal may be the same as the cation component forming the plastic crystal, if the anion included in the plastic crystal is different. The anion included in the plastic crystal may be the same as the anion component forming the plastic crystal, if the cation included in the plastic crystal is different. The cation included in the plastic crystal and the cation component forming the plastic crystal may be different, and the anion included in the plastic crystal and the anion component forming the plastic crystal may be different.

The anion may be various amide anions, a tris(trifluoromethanesulfonyl)methanide anion, various phosphate anions, various borate anions, various sulfonic anions, a tetrafluoroaluminate anion, a mandelate anion, and a benzoate anion of the above chemical formulae (1) to (25). Furthermore, the cation may be various quaternary ammonium cations, various pyrrolidinium cations, various piperidinium cations, various imidazolium cations, and various phosphonium cations of the above chemical formulae (26) to (40).

The contained amount of the combination of the cation and the anion that is different from the cation component and the anion component of the plastic crystal is not limited if they do not shown fluidity and are in the solid state by visual inspection. When the plastic crystal may include the combination of the cation and the anion that is different from the cation component and the anion component of the plastic crystal, the ion conductivity of the electrolyte layer is further improved. The formulation ration of the combination of the cation and the anion that is different from the cation component and the anion component of the plastic crystal may be equimolar amount or different amount. Preferably, the plastic crystal easily keeps its solid shape when the mixed ratio of the ionic liquid is 60 wt % or less.

The plastic crystal may be produced by further adding polymers. The polymer may be polyethylene oxide (PEO), polypropylene oxide, polyester, or carbonate polymers. The carbonate polymer may be polyethylene carbonate (PEC), PEC derivatives, polypropylene carbonate, polytrimethylene carbonate, or copolymers of polytrimethylene carbonate and polycarbonate, etc. The polymer may be used in single or in combination of two or more.

Among these polymers, the carbonate polymer is only an example, and any aliphatic polycarbonate may be used. Furthermore, when using the combination of two or more polymers, each polymer may be homopolymers or copolymers of two or more monomers. Although the molecular weight of the polymer is not limited, it is preferable that the molecular weight of the polymer is 1000 k or more, and it is preferable that the molecular weight of the polyethylene oxide (PEO) is 1000 k or more. By adding the polymer, the mechanical strength of the electrolyte layer is improved, and the ion conductivity of the electrolyte layer is improved.

For example, the plastic crystal can be produced by the below manufacturing method, however, the method is not limited to the below method, and various methods may be used. That is, alkali metal salt of the anion component forming the plastic crystal and the halogenated cation component are each dissolved in the solvent. The alkali metal may be Na, K, Li, or Cs. Halogens may be F, Cl, Br, or I. The solvent is preferably water. Solution of anion metal salt is added drop by drop to the halogenated cation solution, to cause ion exchange reaction. The solution of anion metal salt is added to the halogenated cation solution in equimolar amount, and the mixture is stirred.

At this time, halogenated alkali metal is produced together with the plastic crystal due to ion exchange. When organic solvent such as dichloromethane is added to the mixture and the mixture is placed still, the mixture solution is separated into an aqueous layer and an organic solvent layer. The halogenated alkali metal is removed by removing the aqueous layer from the separated solution. This action may be repeated multiple times. Accordingly, after removing the halogenated alkali metal, the organic solvent such as dichloromethane is evaporated to obtain the plastic crystal.

The plastic crystal is dissolved in a solvent in which the plastic crystal is soluble. The solvent is preferably a polar solvent. The polar solvent may be acetonitrile, propylene carbonate, Y-butyrolactone, dimethyl carbonate, ethylmethyl carbonate, ethylene carbonate, sulfolane, acetone, methanol, ethanol, isopropyl alcohol, or a mixture thereof. These polar solvents efficiently dissolve the plastic crystal, providing excellent productivity of the electrolyte layer. Then, the attaching target to attach the electrolyte layer is impregnated with the solution of plastic crystal. After impregnating the solution of plastic crystal, the target is left under the temperature environment in which the solvent volatilizes, such as 100° C., to volatilize the solvent by drying, and the remaining further volatilized in the temperature moisture is environment, such as 150° C. By this, the plastic crystal is formed on the attaching target.

Note that the plastic crystal may be doped with ionic salt that becomes the electrolyte. The ionic salt may be organic acid salt, inorganic acid salt, or salt of composite compound of organic acid and inorganic acid, and may be used in single or in combination of two or more.

The organic acid may be carboxylic acid such as oxalic acid, succinic acid, glutaric acid, pimelic acid, suberic acid, sebacic acid, phthalic acid, isophthalic acid, terephthalic acid, maleic acid, adipic acid, benzoic acid, toluic acid, enanthic acid, malonic acid, 1,6-decanedicarboxylic acid, 1,7-octanedicarboxylic acid, azelaic acid, undecanedioic acid, dodecanedioic acid, and tridecanedioic acid, phenols, and sulfonic acid, etc. Furthermore, the inorganic acid may be boric acid such as tetrafluoroborate, phosphoric acid, phosphorus acid, hypophosphorous acid, carbonic acid, and silicic acid, etc. The composite compound of organic acid and inorganic acid may be borodisalicylic acid, borodioxalic acid, and borodiglycolic acid.

At least one salt of the organic acid, the inorganic acid, and the composite compound of organic acid and inorganic acid may be ammonium salt, quaternary ammonium salt, quaternary amidinium salt, amine salt, sodium salt, and potassium salt, etc. Quaternary ammonium ions of the quaternary ammonium salt may be tetramethylammonium, triethylmethylammonium, and tetraethylammonium, etc. The quaternary amidinium salt may be ethyldimethylimidazolinium and tetramethylimidazolinium, etc. Amines in the amine salt may be primary amines, secondary amines, and tertiary amines. The primary amine may be methylamine, ethylamine, propylamine, and the like, the secondary amine may be dimethylamine, diethylamine, ethylmethylamine and dibutylamine, and the like, and the tertiary amine may be trimethylamine, triethylamine, tributylamine, ethyldimethylamine, ethyldiisopropylamine, and the like.

Furthermore, the capacity of the electrolytic capacitor including the electrolyte layer containing the conductive polymer and the plastic crystal is improved than that the solid electrolytic capacitor only containing the conductive polymer and not containing the plastic crystal. In particular, it is preferable that the content of the plastic crystal is two to twelve times the content of the conductive polymer by weight. When the content of the plastic crystal is two times or more the content of the conductive polymer, the capacitance of the electrolytic capacitor is improved that the solid electrolytic capacitor only containing the conductive polymer and not containing the plastic crystal, and the ESR is reduced.

However, from the viewpoint of improving the capacitance, the content of the plastic crystal may be more than twelve times the content of the conductive polymer by weight. However, in the plastic crystal attachment process, the solution of plastic crystal is used, and when the content of the plastic crystal is more than twelve times the content of the conductive polymer by weight, the solubility of the plastic crystal decreases, and simple drop impregnation becomes relatively difficult. On the other hand, when the content of the plastic crystal is twelve times or less the content of the conductive polymer by weight, the solubility of the plastic crystal increases. Therefore, by making the content of the plastic crystal to be twelve times or less the content of the conductive polymer by weight, the process to impregnate the attaching target to which the electrolyte layer is attached with the solution of plastic crystal becomes simple.

### (Separator)

The separator includes cellulose such as kraft, Manila hemp, esparto, hemp, rayon, and mixed papers thereof, polyester resin such as polyethylene terephthalate, polybutylene terephthalate, polyethylene naphthalate, and derivatives thereof, polytetrafluoroethylene resin, polyvinylidene fluoride resin, vinylon resin, polyamide resin such as aliphatic polyamide, semi-aromatic polyamide, and total aromatic polyamide, polyimide resin, polyethylene resin, polypropylene resin, trimethylpentene resin, polyphenylene sulfide resin, acrylic resin, polyvinyl alcohol resin and the like, and the resin may be used in single or in combination.

### (Manufacturing Method of Electrolytic Capacitor)

### (Wound-Type)

The assembling process for the wound-type electrolytic capacitor among such electrolytic capacitors is shown as an example. Firstly, the enlarged surface layer is formed on one or both surfaces of the foil of valve action metal at the anode-side, and the dielectric oxide film is formed on the enlarged surface layer by chemical conversion treatment. The enlarged surface layer is also formed on one or both surfaces of the foil of valve action metal at the cathode-side, and the dielectric oxide film is formed on the enlarged surface layer by chemical conversion treatment, as necessary. For example, the anode lead wire and the cathode lead wire are connected to the anode body and the cathode body by stitching, cold-welding, ultrasonic welding, and laser welding, etc.

The long anode body and cathode body are wound via the separator to produce a cylindrical winding body. The separator is overlapped so that one end of the separator protrudes from one end of the anode body and the cathode body. The protruded separator is wound at first so that a core of the winding body is along the short sides of the anode body and the cathode body, to produce a winding core portion. Then, the long sides of the anode body and the cathode body are wound by rounding them as the winding core portion as the winding shaft.

After winding, restorative chemical conversion process to repair defects in a base metal portion of valve action metal exposed when the anode body and the cathode body were cut to the desired width and in the anode body and the cathode body caused by physical stresses such as winding.

In the restorative chemical conversion process, the winding body is immersed in the chemical conversion solution, and voltage is applied. The chemical conversion solution may be phosphoric acid-based chemical conversion solution such as ammonium dihydrogenphosphate, boric acid-based chemical conversion solution such as ammonium borate, adipic acid-based chemical conversion solution such as ammonium adipate, and chemical conversion solution in which boric acid and dicarboxylic acid such as citric acid are mixed, etc. For example, voltage is preferably 0.1 to 1.2 times the chemical conversion voltage. Furthermore, as the voltage application method for the restorative chemical conversion treatment, a method to apply constant voltage from the beginning, or a method to apply voltage increasing stepwise at certain intervals may be selected as appropriate.

Next is the electrolyte formation process to form the electrolyte layer between the anode body and the cathode body. The electrolyte formation process is mainly separated into a polymer attachment process and a plastic crystal attachment process. In the polymer attachment process, the conductive polymer is attached between the anode body and the cathode body, and in the plastic crystal attachment process, the plastic crystal is attached between the anode body and the cathode body.

In the polymer attachment process using the conductive polymer solution, the winding body is immersed in the conductive polymer solution to impregnate the winding body with the conductive polymer solution. To facilitate the impregnation of the conductive polymer solution to the winding body, depressurization process or pressurization process may be performed, if necessary. The impregnation process may be repeated for multiple times. After the conductive polymer solution is impregnated to the winding body, the solvent of the conductive polymer solution is removed by drying process.

To attach the conductive polymer while producing the conductive polymer, the winding body is immersed in the solution of the monomers that are the monomer units of the conductive polymer and the oxidizing agent or the support electrolyte for polymerization reaction. After the conductive polymer is attached, the solvent is removed by drying process.

Next, in the plastic crystal attachment process, the winding body is immersed in the solution of plastic crystal to impregnate the winding body with the solution of plastic crystal. To facilitate the impregnation of the solution of plastic crystal to the winding body, depressurization process or pressurization process may be performed, if necessary. The impregnation process may be repeated for multiple times. After the solution of plastic crystal is impregnated to the winding body, the solvent is removed by drying process.

Regarding the winding body, although the conductive polymer is attached first and then the plastic crystal is attached, the plastic crystal may be attached first and then the conductive polymer may be attached. However, from the viewpoint of forming a conductive path between the anode body and the cathode body, it is preferable to attach the conductive polymer first. By attaching the conductive polymer first, the electrolyte layer containing the plastic crystal and the conductive polymer layer can be uniformly formed, exhibiting excellent capacity characteristic and excellent ESR characteristic.

The conductive polymer and the plastic crystal may be attached to the anode body first, and then the anode body and the cathode body may be wound to face each other via the separator. Otherwise, the conductive polymer and the plastic crystal may be attached to the cathode body, the separator, or both in addition to the anode body, and then the anode body and the cathode body may be wound to face each other via the separator.

The capacitor element is housed in an outer casing with one end closed and the other end opened, and is sealed in the outer casing by a sealing body. Then, after the capacitor element is sealed in the outer casing, aging process is performed to complete the electrolytic capacitor. In the aging process, DC current is applied to the electrolytic capacitor to repair the defects such as in the dielectric oxide film.

### (Laminated Type)

The assembling process for the laminated-type electrolytic capacitor among such electrolytic capacitors is shown as an example. Firstly, the surface enlarged layer is formed on the surface of the foil of valve action metal that is the anode body. Next, the chemical conversion treatment is performed on the foil on which the enlarged surface layer is formed in the chemical conversion solution to form the dielectric oxide film on the surface of the foil of valve action metal. An insulation resist layer is printed and dried on the foil including a region that becomes a terminal at the anode side, except for a region that becomes the anode. That is, the insulation resist layer is printed so that the electrolyte layer will not be formed on the region that becomes the terminal at the anode side.

After printing the insulation resist layer, the conductive polymer attachment process is performed, where the foil is immersed in the conductive polymer solution to attach the conductive polymer to cover the dielectric oxide film. After the solvent of the conductive polymer solution is removed by drying, the plastic crystal attachment process is performed, where the foil is immersed in the solution of plastic crystal to attach the plastic crystal. Then, the solvent of the plastic crystal is removed by drying. By such attachment of the conductive polymer and the plastic crystal, the electrolyte layer is formed.

Next, carbon paste is printed on the electrolyte layer by a screen printer and the like, and is dried. By this drying process, the carbon layer is formed on electrolyte layer. Furthermore, metal paste such as silver paste is printed on the carbon layer and is dried. By this drying process, the silver layer is formed on the carbon layer. These carbon layer and silver layer correspond to the cathode body of the electrolytic capacitor.

After the cathode body is formed, the insulation resist layer is peeled off. Note that the insulation resist layer may be peeled off using laser irradiation or mechanical peeling by pressing a jig. A portion exposed by peeling is plated to complete the terminal at the anode side.

For example, the capacitor element produced as such is coated by laminate film. Otherwise, the capacitor element is sealed by molding, dip coating, or printing resin such as heat-resistant resin and insulation resin.

Hereinafter, the manufacturing method of the electrolytic capacitor will be described in more detail based on the examples. Note that the present disclosure is not limited to the below examples.

### Examples 1 to 4

Electrolytic capacitors of the examples 1 to 4 and the comparative example 1 were produced as follows. Firstly, a pair of electrodes was produced using aluminum foil. Surfaces of both electrode foil were enlarged by etching. One of the electrodes was the anode body, and the surface thereof was enlarged by DC etching. In the surface enlargement process of the anode body, DC current was applied to the aluminum foil in aqueous solution containing hydrochloric acid to form pits, and then DC current was applied to the aluminum foil in aqueous solution containing nitric acid to enlarge the pits. The other of the electrode was the cathode body, and the surface thereof was enlarged by AC etching. In the formation of the enlarged surface layer of the cathode body, AC current was applied to the aluminum foil in aqueous solution containing hydrochloric acid to form spongy etching pits.

Chemical conversion treatment was performed on the anode body to form dielectric oxide film on the surface of the of the foil. In the chemical conversion treatment, current with current density of 10 mA/cm² was conducted in aqueous solution of ammonium dihydrogenphosphate with concentration of 1.4 g/L and temperature of 90° C., and was maintained for 10 minutes after the chemical conversion voltage reached 56.5 V.

These anode body and the cathode body were each connected to lead wire and were wound via a manila-paper separator so that the anode foil and the cathode foil faced each other. The winding body had diameter of 10 mm and height of 10 mm. The winding body was conducted with applied voltage of 56.5 V and current density of 10 mA in aqueous solution of ammonium dihydrogenphosphate with temperature of 90° C. for 10 minutes to perform restorative chemical conversion.

The winding body was at first impregnated with conductive polymer solution. In the conductive polymer, poly(3,4-ethylenedioxythiophene) doped with polystyrene sulfonic acid (dispersed. PEDOT/PSS was added in a ratio of 1.2 wt % relative to the total conductive polymer solution. Furthermore, ethylene glycol was added to the conductive polymer solution in a ratio of wt % relative to the conductive polymer dispersion. The winding body was impregnated with the conductive polymer solution for 10 minutes in the pressurized environment of −0.3 MPa at room temperature. The impregnation process was performed twice.

After the winding body was pulled out from the conductive polymer solution, the winding body was placed still at room temperature for 10 minutes and was further placed still in the temperature environment of 110° C. for 30 minutes to dry the winding body. By this, an electrolyte layer containing the conductive polymer was formed on the dielectric oxide film of the anode body.

Next, in the examples 1 to 4, plastic crystals were attached between the anode body and the cathode body, in addition to the conductive polymer. The plastic crystals in the examples 1 to 4 were as the below table 1.

TABLE 1

| | Conductive Polymer | Plastic Crystal |
|---|---|---|
| Example 1 | PEDOT/PSS | P12BF₄ |
| Example 2 | | P12FSA |
| Example 3 | | P12BoB |
| Example 4 | | P12BScB |
| Comparative | | — |
| Example 1 | | |

As shown in the table 1, in the example 1, P12BF₄ was attached as the plastic crystal. That is, the plastic crystal including P12 cations and BF₄ anions in a molar ratio of 1:1 was attached. The P12 cation was a N-ethyl-N-methylpyrrolidinium cation expressed by the chemical formula (30).

In the example 2, P12SA was attached as the plastic crystal. That is, the plastic crystal including P12 cations and FSA anions in a molar ratio of 1:1 was attached. The FSA anion was a bis(fluorosulfonyl) anion expressed by the chemical formula (5).

In the example 3, P12BoB was attached as the plastic crystal. That is, the plastic crystal including P12 cations and BoB anions in a molar ratio of 1:1 was attached. The BoB anion was a bis(oxalato)borate anion expressed by the chemical formula (18A).

In the example 4, P12BScB was attached as the plastic crystal. That is, the plastic crystal including P12 cations and BScB anions in a molar ratio of 1:1 was attached. The BScB anion was a bis(salicylato)borate anion expressed by the chemical formula (19A).

The plastic crystal was added to acetonitrile in a ratio of 40 wt % relative to the total solution. This acetonitrile solution was dropped on the winding body to impregnate the winding body with acetonitrile solution. The impregnation amount was 570 mg for one winding body.

After the impregnation, the winding body was placed still under the argon atmosphere at temperature of 45° C. for 2 hours, under the argon atmosphere at temperature of 60° C. for 2 hours, under the argon atmosphere at temperature of 80° C. for 2 hours, and finally under the argon atmosphere at temperature of 100° C. for 12 hours, to dry the acetonitrile solution. By this, in the examples 1 to 4, the electrolyte layer containing the conductive polymer and the plastic crystal was formed. In the comparative example 1, the electrolyte layer containing the conductive polymer and not containing the plastic crystal was formed.

The capacitor elements of the examples 1 to 4 and the comparative example 1 were housed in an outer casing, and the opening of the outer casing was sealed by a sealing body. The sealing body and the outer casing were adhered by press-fitting. Then, voltage of 40.25 V was applied on the electrolytic capacitors of the examples 1 to 6 and the comparative example 1 exposed under the temperature environment of 105° C. for 1 hour to perform aging. As a result, the electrolytic capacitors each with diameter of 10 mm and height of 10 mm, rated voltage of 36 WV, and 270 μF were produced.

The capacitance (Cap), the equivalent series resistance (ESR), and the dissipation factor (tan δ) of the electrolytic capacitors of the examples 1 to 4 and the comparative examples 1 were measured. The Cap, tan δ, and ESR were measured using a LCR meter (ZM2376 from NF Corporation) at room temperature. The measurement frequency of the Cap, ESR, and tan δ was 120 Hz, and the AC current level was sine wave of 1.0 Vms.

The Cap, ESR and the tan δ of the electrolytic capacitors of the examples 1 to 4 and the comparative example 1 are shown in the below table 2.

TABLE 2

| | | | Capacity | ESR | |
|---|---|---|---|---|---|
| | Conductive | Plastic | (μF) | (mΩ) | tanδ |
| | Polymer | Crystal | 120 Hz | 120 Hz | 120 Hz |
| Example 1 | PEDOT/PSS | P12BF₄ | 249.1 | 275.4 | 0.052 |
| Example 2 | | P12FSA | 209.3 | 815.1 | 0.129 |
| Example 3 | | P12BoB | 200.9 | 579.4 | 0.088 |
| Example 4 | | P12BScB | 215.4 | 491.6 | 0.080 |
| Comparative | | — | 133.9 | 882.6 | 0.089 |
| Example 1 | | | | | |

As shown in the table 2, it was observed that, the capacity of the electrolytic capacitors of the examples 1 to 4 including the electrolyte layer containing the conductive polymer and the plastic crystal had improved compared to that of the solid electrolytic capacitor only containing the conductive polymer and not containing the plastic crystal. Note that the ESR and tan δ of the electrolytic capacitors in the examples 1 to 4 were also in the satisfactory range, and were even better than the comparative example 1 in some of the examples.

### Examples 5 to 6

Electrolytic capacitors of the example 5 and 6 were produced. In the examples 5 and 6, ionic liquid was included in the plastic crystal. The configuration, the structure, the production method and condition of the electrolytic capacitors of the examples 5 and 6 were the same as those of the electrolytic capacitors of the examples 1 to 4, except that the plastic crystal included the ionic liquid.

In the example 5, the plastic crystal was P12BF₄ including P12 cations and BF₄ anions in a molar ratio of 1:1. The ionic liquid was EMIBF₄ containing EMI cations and BF₄ anions in a molar ratio of 1:1. The EMI cation was a 1-ethyl-3-methylimidazolium cation expressed by the chemical formula (38). P12BF₄ and EMIBF₄ were prepared in an equimolar amount.

In the example 6, the plastic crystal was P12FSA including P12 cations and FSA anions in a molar ratio of 1:1. The ionic liquid was EMIFSA containing EMI cations and FSA anions in a molar ratio of 1:1. P12FSA and EMISFA were prepared in an equimolar amount.

The capacitance (Cap), the equivalent series resistance (ESR), and the dissipation factor (tan δ) of the electrolytic capacitors of the examples 5 and 6 were measured using the same condition as those of the examples 1 to 4 and the comparative example 1. The Cap, ESR and the tan δ of the electrolytic capacitors of the examples 5 and 6 are shown in the below table 3.

TABLE 3

| | | | | Capacity | ESR | |
|---|---|---|---|---|---|---|
| | Conductive | Plastic | Tonic | (μF) | (mΩ) | tanδ |
| | Polymer | Crystal | Liquid | 120 Hz | 120 Hz | 120 Hz |
| Example 5 | PEDOT/ | P12BF₄ | EMIBF₄ | 248.3 | 183.2 | 0.034 |
| Example 6 | PSS | P12FSA | EMIFSA | 243.8 | 218.0 | 0.040 |
| Comparative | | — | — | 133.9 | 882.6 | 0.089 |
| Example 1 | | | | | | |

As shown in the table 3, it was observed that when the plastic crystal including a combination of a cation and an anion that is different from the cation component and the anion component of the plastic crystal had been used, the capacity significantly had improved compared to the comparative example 1. Furthermore, it was observed that the ESR and tan δ of the electrolytic capacitors of the examples 5 and 6 had clearly and dramatically improved compared to the comparative example 1.

### Examples 7 to 9

The electrolytic capacitors of the examples 7 to 9 and the comparative example 2 were produced. The type of the plastic crystal of the electrolytic capacitors of the examples 7 to 9 were different from those of the examples 1 to 4. The configuration and the production method of the electrolytic capacitor of the comparative example 2 were the same as those of the comparative example 1, except for the size of the winding body. The winding bodies of the examples 7 to 9 and the comparative example 2 were different from those of the examples 1 to 4 and had the diameter of 6.8 mm and the height of 5.8 mm.

In the example 7, P12BScB was attached as the plastic crystal. That is, the plastic crystal including P12 cations and BScB anions in a molar ratio of 1:1 was attached. The BScB anion was a bis(salicylato)borate anion expressed by the chemical formula (19A).

In the example 8, P12BmScB was attached as the plastic crystal. That is, the plastic crystal including P12 cations and BmScB anions in a molar ratio of 1:1 was attached. The BmScB anion was a bis(methylsalicylato)borate anion expressed by the chemical formula (19C).

In the example 9, TEABhNB was attached as the plastic crystal. That is, the plastic crystal including TEA cations and BhNB anions in a molar ratio of 1:1 was attached. The TEA cation is a tetraethylammonium cation (TEA cation) expressed by the chemical formula (27). The BhNB anion was a bis(2-hydroxy-1-naphtholato)borate anion expressed by the chemical formula (20B).

The plastic crystals of the examples 7 and 8 were added to γ-butyrolactone in a ratio of 50 wt % relative to the total solution. The plastic crystal of the example 9 was added to γ-butyrolactone in a ratio of 25 wt % relative to the total solution. This γ-butyrolactone solution was dropped on the winding body to impregnate the winding body with the γ-butyrolactone solution. The γ-butyrolactone solution was impregnated at room temperature in the depressurized environment of −80 kPa for 30 minutes. At this time, −80 kPa was the gauge pressure taking the atmospheric pressure s the reference, the pressure expressed by negative pressure was the gauge pressure taking the atmospheric pressure.

After the impregnation, the winding body was placed still in the depressurized environment of −100 kPa at room temperature for one night, in the depressurized environment of −100 kPa at temperature of 45° C. for 2 hours, in the depressurized environment of −100 kPa at temperature of 60° C. for 2 hours, in the depressurized environment of −100 kPa at temperature of 80° C. for 2 hours, and finally in the depressurized environment of −100 kPa at temperature of 90° C. for one night, to sufficiently dry the γ-butyrolactone solution and remove the γ-butyrolactone. By this, in the examples 7 to 9, the electrolyte layer containing the conductive polymer and the plastic crystal was formed. In the comparative example 2, the electrolyte layer containing the conductive polymer and not containing the plastic crystal was formed.

The capacitance (Cap), the equivalent series resistance (ESR), and the dissipation factor (tan δ) of the electrolytic capacitors of the examples 7 to 9 and the comparative examples 2 were measured. The measurement condition was the same as those of the examples 1 to 4 and the comparative examples 1.

The Cap, ESR and the tan δ of the electrolytic capacitors of the examples 7 to 9 and the comparative example 2 are shown in the below table 4.

TABLE 4

| | | | Capacity | ESR | |
|---|---|---|---|---|---|
| | Conductive | Plastic | (μF) | (mΩ) | tanδ |
| | Polymer | Crystal | 120 Hz | 120 Hz | 120 Hz |
| Example 7 | PEDOT/PSS | P12BScB | 37.4 | 1933 | 0.055 |
| Example 8 | | P12BmScB | 38.6 | 2450 | 0.069 |
| Example 9 | | TEABhNB | 36.3 | 2466 | 0.067 |
| Comparative | | — | 33.9 | 2418 | 0.067 |
| Example 2 | | | | | |

As shown in the table 4, it was observed that, the capacity of the electrolytic capacitors of the examples 7 to 9 including the electrolyte layer containing the conductive polymer and the plastic crystal had improved compared to that of the solid electrolytic capacitor only containing the conductive polymer and not containing the plastic crystal. Note that the ESR and tan δ of the electrolytic capacitors in the examples 7 to 9 were also in the satisfactory range, and the example 7 was even better than the comparative example 2.

### Examples 10 to 14

The electrolytic capacitors of the examples 10 to 14 example 3 were produced. The and the comparative configuration and the production method of the electrolytic capacitors of the examples 10 to 14, where P12BScB was attached as the plastic crystal, were the same as those of the example 7. Furthermore, the configuration and the production method of the comparative example 3 were the same as those of the comparative example 1. The content of the conductive polymer and the content of the plastic crystal could be determined by measuring the weight before and after each attachment process, and the weight of the conductive polymer contained in the electrolytic capacitors of the examples 10 to 14 was 3 mg.

However, the electrolytic capacitors of the examples 10 to 14 had different weight ratios of the conductive polymer and the plastic crystal. In the example 10, the weight of plastic crystal was 0.2 times the weight of the conductive polymer. In the example 11, the weight of plastic crystal was 1 times the weight of the conductive polymer. In the example 12, the weight of plastic crystal was 2 times the weight of the conductive polymer. In the example 13, the weight of plastic crystal was 5 times the weight of the conductive polymer. In the example 14, the weight of plastic crystal was 12 times the weight of the conductive polymer.

The capacitance (Cap) and the equivalent series resistance (ESR) of the electrolytic capacitors of the examples 10 to 14 and the comparative examples 3 were measured. The Cap, tan δ, and ESR were measured using a LCR meter (ZM2376 from NF Corporation) at room temperature. The measurement frequency of the Cap was 10 kHz, the measurement frequency of the ESR was 100 kHz, and the AC current level was sine wave of 1.0 Vms.

The Cap and ESR of the electrolytic capacitors of the examples 10 to 14 and the comparative example 3 are shown in the below table 5.

TABLE 5

| | | | Weight | | |
|---|---|---|---|---|---|
| | | | Ratio | Capac- | |
| | | | to Con- | ity | ESR |
| | Conductive | Plastic | ductive | (μF) | (mΩ) |
| | Polymer | Crystal | Polymer | 10 kHz | 100 kHz |
| Comparative | PEDOT/PSS | — | 0 | 20.5 | 99.8 |
| Example 3 | | | | | |
| Example 10 | | P12BScB | 0.2 | 23.8 | 102.3 |
| Example 11 | | | 1 | 24.5 | 101.7 |
| Example 12 | | | 2 | 24.9 | 98.6 |
| Example 13 | | | 5 | 24.0 | 92.3 |
| Example 14 | | | 12 | 27.7 | 70.5 |

As shown in the table 5, the capacitance of the electrolytic capacitors of the examples 10 to 14 was higher than that of the comparative example 3. Furthermore, the ESR of the electrolytic capacitors of the examples 10 to 14 was excellent compared to the comparative example 3. Accordingly, it was observed that when the content of the plastic crystal was two to twelve times the content of the conductive polymer by weight, the capacitance of the electrolytic capacitor was high and the ESR of the electrolytic capacitor was excellent.

1. An electrolytic capacitor comprising an electrolyte layer containing a conductive polymer and a plastic crystal,
wherein an amount of the plastic crystal is two to twelve times the amount of the conductive polymer by weight.

2. The electrolytic capacitor according to claim 1, wherein the conductive polymer includes poly(3,4-ethylenedioxythiophene and polystyrene sulfonic acid.

3. The electrolytic capacitor according to claim 1, wherein the plastic crystal further includes a combination of a cation and an anion that is different from a cation component and an anion component of the plastic crystal.

4. The electrolytic capacitor according to claim 1, wherein an anion component of the plastic crystal is a borate anion expressed by a chemical formula (18), 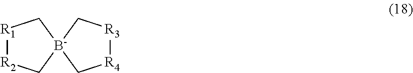
and in the chemical formula (18),
R1 and R2 are each independently a ketone group or a benzyl group with one hydrogen atom at a benzyl position removed, or R1 and R2 are carbon atoms in a common aromatic 6-membered ring, and
R3 and R4 are each independently a ketone group or a benzyl group with one hydrogen atom at a benzyl position removed, or R3 and R4 are carbon atoms in a common aromatic 6-membered ring.

5. The electrolytic capacitor according to claim 1, wherein an anion component of the plastic crystal is a borate anion expressed by a chemical formula (19), 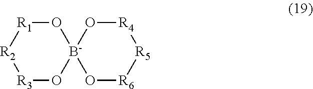
and in the chemical formula (19),
R1 to R6 are each independently a ketone group or a methylene group, or
either of R1 or R3 is a ketone group or a methylene group,
other combination of R1 and R2 or R2 and R3 is a carbon atom of a common aromatic 6-membered ring,
either of R4 or R6 is a ketone group or a methylene group,
other combination of R4 and R5 or R5 and R6 is a carbon atom of a common aromatic 6-membered ring, and
the aromatic 6-membered ring has one or four methyl groups and is a part of a polycyclic aromatic ring with two or more aromatic rings like a naphthalene ring.

6. The electrolytic capacitor according to claim 1, wherein an anion component of the plastic crystal is one of a tetrafluoroborate anion, a bis(fluorosulfonyl)amide anion, a bis(oxalato)borate anion, a bis(salicylato)borate anion, a bis(methylsalicylato)borate anion, and a bis(2-hydroxy-1-naphtholato)borate anion.

7. A manufacturing method of an electrolytic capacitor, comprising an electrolyte layer formation process of forming an electrolyte layer between a pair of electrodes, wherein the electrolyte layer formation process includes:
a conductive polymer attachment process of attaching a conductive polymer on one or both of the pair of electrodes, and
a plastic crystal attachment process of attaching a plastic crystal on one or both of the pair of electrodes, including dissolving the plastic crystal in a soluble solvent until an amount of the plastic crystal is two to twelve times the amount of the conductive polymer by weight, immersing at least the electrode in solution in which the plastic crystal is dissolved, and impregnating at least the electrode with the solution of the plastic crystal.

8. The manufacturing method of the electrolytic capacitor according to claim 7, wherein:
one of the pair of the electrodes is a foil body of valve action metal and is an anode body in which dielectric oxide film is formed on the foil body, and
the other of the pair of the electrodes is a cathode body.

9. The manufacturing method of the electrolytic capacitor according to claim 7, wherein the conductive polymer attachment process includes an impregnation process of impregnating liquid containing the conductive polymer between the pair of electrodes.

10. The manufacturing method of the electrolytic capacitor according to claim 7, wherein in the plastic crystal attachment process, the plastic crystal including a combination of a cation and an anion that is different from a cation component and anion component of the plastic crystal is attached.
